(19) United States
(12) Patent Application Publication
(10) Pub. No.: US 2014/0201055 A1
(43) Pub. Date: Jul. 17, 2014

(54) Methods and Systems for Creating and Trading Derivative Investment Products Based on a Covariance Index

(71) Applicant: Catherine T. Shalen, Chicago, IL (US)

(72) Inventor: Catherine T. Shalen, Chicago, IL (US)

(73) Assignee: Chicago Board Options Exchange, Incorporated, Chicago, IL (US)

(21) Appl. No.: 14/070,993

(22) Filed: Nov. 4, 2013

Related U.S. Application Data
(60) Provisional application No. 61/752,628, filed on Jan. 15, 2013.

(51) Int. Cl. G06Q 40/04

(52) U.S. Cl. CPC G06Q 40/04
USPC 705/37

(57) ABSTRACT

Systems and methods for determining an index based on a covariance between two underlying assets is disclosed. In one implementation, a processor of a trading platform calculates a covariance index associated with two underlying assets, creates a covariance derivative associated with the two underlying assets based on the covariance index, and displays the covariance index and the covariance derivative on a trading display device coupled with the trading platform.

### RELATED APPLICATION

The present application claims priority to U.S. Provisional Patent Application No. 61/752,628, filed Jan. 15, 2013, the entirety of which is hereby incorporated by reference.

### FIELD OF THE DISCLOSURE

The present disclosure relates to derivative investment markets. More specifically, the present disclosure relates to aspects of actively creating, disseminating, trading, and auctioning derivatives.

### BACKGROUND

A derivative is a financial security whose value is derived in part from a value or characteristic of another security, known as an underlying asset. Two exemplary and well known derivatives are options and futures.

An option is a contract that gives the contract holder a right, but not an obligation, to buy or sell an underlying asset at a specific price on or before a certain date. Generally, a party who purchases an option is referred to as the holder of the option and a party who sells an option is referred to as the writer of the option.

There are generally two types of options: call and put options. A holder of a call option receives a right to purchase an underlying asset at a specific price, i.e., the “strike price.” If the holder exercises the call option, the writer is obligated to deliver the underlying asset to the holder at the strike price. Alternatively, the holder of a put option receives a right to sell an underlying asset at a specific price, i.e., the “strike price.” If the holder exercises the put option, the writer is obligated to purchase the underlying asset at the agreed upon strike price. Thus, the settlement process for an option may involve the transfer of funds from the purchaser of the underlying asset to the seller of the underlying asset, and the transfer of the underlying asset from the seller of the underlying asset to the purchaser of the underlying asset. This type of settlement may be referred to as “in kind” settlement. However, an underlying asset of an option need not be tangible, transferable property.

Options may also be based on more abstract market indicators, such as stock indices, interest rates, futures contracts and other derivatives. In these cases, “in kind” settlement may not be desired and/or possible. In these cases, the contracts are “cash settled.” For example, using cash settlement, a holder of an index call option receives the right to “purchase” not the index itself, but rather a cash amount equal to the value of the index multiplied by a multiplier, e.g., $100. Thus, if a holder of an index call option exercises the option, the writer of the option must pay the holder the difference between the current value of the underlying index and the strike price multiplied by the multiplier. However, the holder of the index will only realize a profit if the current value of the index is greater than the strike price. If the current value of the index is less than or equal to the strike price, the option is worthless due to the fact that the holder would realize a loss.

Similar to options contracts, futures contracts may also be based on abstract market indicators. Futures contracts give a buyer of the future a right to receive delivery of an underlying commodity or asset on a fixed date in the future. Accordingly, a seller of the future contract agrees to deliver the commodity or asset on the specified date for a given price. Typically, the seller will demand a premium over the prevailing market price at the time the contract is made in order to cover the cost of carrying the commodity or asset until the delivery date.

Although futures contracts generally confer an obligation to deliver an underlying asset on a specified delivery date, the actual underlying asset need not change hands. Instead, futures contracts may be cash settled. To cash settle a future, the difference between a market price and a contract price is paid by one investor to the other. Again, like options, cash settlement allows futures contracts to be created based on more abstract “assets” such as market indices. To cash settle index futures, the difference between the contract price and the price of the underlying asset (i.e., current value of market index) is exchanged between the investors to settle the contract.

Derivatives such as options and futures may be traded over-the-counter, and/or on other trading facilities such as organized exchanges. In over-the-counter transactions the individual parties to a transaction are free to customize each transaction as they see fit. With trading platform-traded derivatives, a clearing corporation stands between the holders and writers of derivatives. The clearing corporation matches buyers and sellers, and settles the trades. Thus, cash or the underlying assets are delivered, when necessary, to the clearing corporation and the clearing corporation disperses the assets as necessary as a consequence of the trades. Typically, such standard derivatives will be listed as different series expiring each month and representing a number of different incremental strike prices. The size of the increment in the strike price will be determined by the rules of the trading platform, and will typically be related to the value of the underlying asset.

Additionally, there are two widely utilized methods by which derivatives are currently traded: (1) order-matching and (2) principal market making. Order matching is a model followed by exchanges such as the Chicago Board of Trade, the Chicago Mercantile Exchange, and some newer online exchanges. In order matching, the exchange coordinates the activities of buyers and sellers so that “bids” to buy can be paired off with “offers” to sell. Orders may be matched both electronically and through the primary market making activities of the exchange members. Typically, the exchange itself takes no market risk and covers its own cost of operation by selling memberships to brokers. Member brokers may take principal positions, which are often hedged across their portfolios.

In principal market making, a bank or brokerage firm, for example, establishes a derivatives trading operation, capitalizes it, and makes a market by maintaining a portfolio of derivatives and underlying positions. The market maker usually hedges the portfolio on a dynamic basis by continually changing the composition of the portfolio as market conditions change. In general, the market maker strives to cover its cost of operation by collecting a bid-offer spread and through the scale economies obtained by simultaneously hedging a portfolio of positions. As the market maker takes significant market risk, its counterparties are exposed to the risk that it may go bankrupt. Additionally, while in theory the principal market making activity could be done over a wide area network, in practice derivatives trading is usually accomplished via the telephone. Often, trades are processed laboriously, with many manual steps required from the front office transaction to the back office processing and clearing.

Generally, the return to a trader of a traditional derivative product is largely determined by the value of the underlying security, asset, liability, or claim on which the derivative is based. For example, the value of a call option on a stock, which gives the holder the right to buy the stock at some future date at a fixed strike price, varies directly with the price of the underlying stock. In the case of non-financial derivatives such as reinsurance contracts, the value of the reinsurance contract is affected by the loss experienced on the underlying portfolio of insured claims. The prices of traditional derivative products are usually determined by supply and demand for the derivative based on the value of the underlying security (which is itself generally determined/influenced by supply and demand, or, as in the case of insurance, by events insured by the insurance or reinsurance contract).

While standard derivative contracts may be based on many different types of market indexes or statistical properties of underlying assets, there is a need for a standard derivative contract based on a covariance associated with two or more underlying assets.

### BRIEF SUMMARY

Accordingly, the present disclosure relates to methods and systems for creating and disseminating a covariance index reflecting a covariance associated with two or more underlying assets, as well as methods and system for creating and auctioning derivative contracts based on the covariance index.

In one aspect, a method of determining an index based on a covariance between two underlying assets is disclosed. In the method, a processor in a trading platform calculates a covariance index associated with two underlying assets; creates a covariance derivative associated with the two underlying assets based on the covariance index; and displays the covariance index and the covariance derivative on a trading platform display device coupled with the trading platform.

In another aspect, a trading system is disclosed. The trading system includes a display device, a memory, and a processor. The memory stores a set of instructions for calculating a covariance index associated with two underlying assets and creating a covariance derivative associated with the two underlying assets based on the covariance index. The processor is in communication with the display device and the memory, and is configured to execute the set of instructions stored in the memory. The processor is further configured to calculate a covariance index associated with two underlying assets; create a covariance derivative associated with the two underlying assets based on the covariance index; and display the covariance index associated with the two underlying assets and the covariance derivative on the display device.

In a further aspect, a method of creating a covariance derivative is disclosed. In the method, a covariance index associated with two underlying assets is accessed. A processor then creates a covariance derivative based on the index and transmits information associated with the covariance index for display.

In an additional aspect, a system including a memory and a processor is disclosed. The memory stores a set of instructions for creating a covariance derivative. The processor is in communication with the memory and is configured to execute the set of instructions. The processor is further configured to access a covariance index associated with two underlying assets, create a covariance derivative based on the covariance index, and transmit information associated with the covariance derivative for display.

In any of the covariance derivatives, a first underlying asset of the covariance derivative may represent a first sector of a portfolio and a second underlying asset of the covariance derivative may represent a second sector of the portfolio. Further, the first sector and the second sector may each comprise one or more of commodity or structured products traded on a trading platform or over-the-counter market; equity indexes or securities; fixed income indexes or securities; foreign currency exchange rates; interest rates; and commodity indexes

### BRIEF DESCRIPTION OF THE DRAWINGS

FIG. 1 is a flow chart of one implementation of a method for calculating and disseminating a covariance index and for creating and trading covariance derivative contracts that are based on the covariance index.

FIG. 2 illustrates an electronic trading system that may be used for creating and disseminating a covariance index and/or creating, listing and trading covariance derivative contracts that are based on a covariance index.

FIG. 3 shows one implementation of exchange backend systems used for creating and disseminating a covariance index and/or creating, listing and trading covariance derivative contracts that are based on a covariance index.

FIG. 4 is an illustrative embodiment of a general computer system that may be used for one or more of the components shown in FIG. 3.

### DETAILED DESCRIPTION OF THE DRAWINGS

Covariance derivatives are financial instruments such as futures and options contacts that trade on trading facilities, such as exchanges, whose value is based on an implied dispersion between returns associated with two or more underlying assets (also known as the covariance between the two or more underlying assets). In some implementations, a covariance index may be derived from the returns or prices of contracts on the returns of (a) the different assets and (b) a portfolio of these different assets (e.g., returns of the S&P 500® or CBOE Volatility Index® and its S&P 500 economic sectors, or prices of options on the S&P 500 and its economic sectors).

Generally, variance measures a variation of a random variable. Covariance measures the covariation of two random variables, x and y. For a portfolio comprising multiple assets, a risk of the portfolio generally depends on the covariance of every pair of assets within the portfolio. Covariance risk blends correlation and volatility risk.

Derivative contracts that settle to a covariance index, and by extension, to a covolatility index, provide portfolio inventors and issuers of structured products the ability to hedge their exposure to covariance risk associated with two or more underlying assets and offers investors a complement to other derivatives that are a close proxy to a standard deviation of an underlying asset. For example, with respect to S&P 500® returns, covariance derivatives offer a complement to derivatives based on CBOE Volatility Index® (VIX®).

Those skilled in the art will recognize that covariance derivatives having features similar to those described herein and statistical properties which reflect an implied dispersion between returns associated with two or more underlying assets, but which are given labels other than covariance derivatives, covariance futures, or covariance options will nonetheless fall within the scope of the present disclosure.

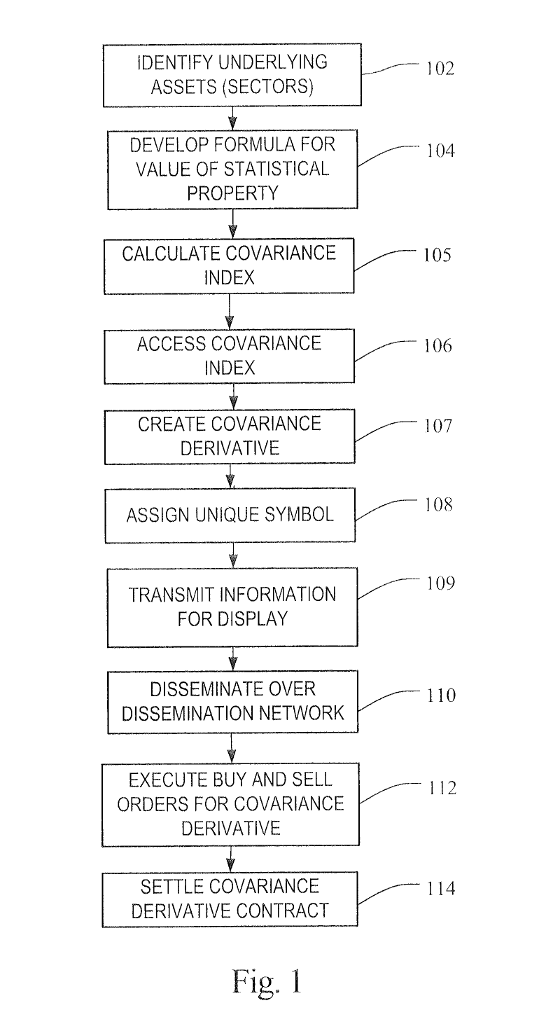

FIG. 1 is a flow chart of one implementation of a method for calculating and disseminating a covariance index and for creating and trading covariance derivative contracts that are based on the covariance index 200, such as a covariance futures contract or a covariance options contract. A covariance derivative contract is a financial instrument that settles to the realized or expected covariance index of two or more underlying assets. The covariance index reflects the realized or expected dispersion between the returns associated with the two or more underlying assets. As explained in more detail below, covariance measures the degree to which the returns of multiple assets move together.

According to one embodiment of the present invention, an investor is able to purchase a covariance derivative contract before a calculation period begins, or an investor may trade into or out of a covariance derivative contract during the calculation period before an expiration of the covariance derivative contract. To facilitate the purchase and trading of covariance derivative contracts, trading facilities, such as exchanges like the CBOE Futures Exchange or the CBOE Options Exchange, will regularly calculate and disseminate a covariance index associated with two or more underlying assets. According to one embodiment of the present invention, the covariance index is calculated daily, while in other embodiments of the present invention the covariance index is calculated in real-time, multiple times per day, or in other regular or irregular time increments.

The method for creating and trading a covariance derivative contract begins at step 102 by identifying a set of underlying assets for the covariance derivative contract. Typically, a set of assets is selected based on trading volume of a prospective set of underlying assets, the general level of interest of market participants in a prospective set of underlying assets, or for any other reason desired by a trading platform. The set of underlying assets for the covariance derivative contract may be equity indexes or securities; fixed income indexes or securities; foreign currency exchange rates; interest rates; commodity indexes; commodity or structured products traded on a trading platform or in the over-the-counter (“OTC”) market; or any other type of underlying asset whose value may change from day to day.

In some implementations, each underlying asset of the set of assets may represent a different sector comprising components that are associated with a common characteristic, such as an economic sector, a geographical sector, a growth sector, a value sector, or any other type of sector as used by those of skill in the art. It will be appreciated that each sector may also include a group including one or more of equity indexes or securities; fixed income indexes or securities; foreign currency exchange rates; interest rates; commodity indexes; commodity or structured products traded on a trading platform or in the OTC market; or any other type of underlying asset whose value may change from day to day.

In one example, a covariance derivative contract may be a covariance options contract that is based on a covariance index reflecting an expected or realized covariance between two different economic sector of the S&P 500, such the expected or realized covariance between the S&P 500 energy sector and the S&P 500 industrials sector. In this example, a first underlying asset is the S&P 500 energy sector; a second underlying asset is the S&P 500 industrials sector; the calculation period is 30 days, and the covariance index is calculated from prices of options of indexes and options that are associated with securities that are associated with the S&P 500 energy sector or the S&P 500 industrials sector. However, it will be appreciated that a covariance future or options may be based on any realized or expected covariance associated with any sector partitions of any portfolio and that the calculation period may be any set number of days.

Once the set of underlying assets has been selected at 102, a formula is developed at 104 for generating a value for a statistical property reflecting an expected or realized dispersion between returns associated with the underlying assets of the set of underlying assets, also known as the covariance of the set of underlying assets.

In some implementations, a formula is developed at 104 for the covariance index based on the equation:

cov(R₁,R₂)=E[(R₁−E[R₁])(R₂−E[R₂])=ρ_{1,2}σ₁σ₂

where R₁ is a return of a first underlying asset of the two underlying assets, R₂ is a return of the second underlying asset of the two underlying assets, E[x] is an expected value of x, σ₁ is a standard deviation of a return of the first underlying asset, σ₂ is a standard deviation of a return of the second underlying asset, and ρ_{1,2} is a correlation between the rate of return of the first underlying asset and the rate of return of the second underlying asset.

The correlation (ρ_{1,2}) is a scaleless measure of covariation between two returns bound between −1 and 1. The covariance is not scaleless, and its value depends on the correlation and on the standard deviations. Those of skill in the art will appreciate that covariance measures an extent to which two variables move together, and that covariance blends the size of the moves (the sigmas or standard deviations) with correlation that measure whether or not the variables move in the same or opposite direction.

The formula is further developed at 104 for calculating a covariance index based on the equation:

$$var [ {R}_{I} ] = {\sum }_{i} {w}_{i}^{2} {σ}_{i}^{2} + {\sum }_{i} {\sum }_{l \neq i} {w}_{i} {w}_{l} cov [ {R}_{i} , {R}_{l} ]$$

$$i , l = 1 , … N ,$$

representing a variance of an index or portfolio having N components. It will be appreciated that in this equation, a portion of the variance of the portfolio comes from the variance of the components of the portfolio and the remaining portion of the variance comes from the covariation of the components of the portfolio.

In one implementation, where the underlying assets are each different sectors, the above equations are used to derive a formula for calculating an expected covariance index based on defining variances as the quadratic variations of instantaneous rates of return on a path to a final date T. The expected quadratic variation of the return of an asset can be estimated by a weighted sum of prices of at- and out-of-the-money options of the asset (as done for the purpose of calculating the CBOE VIX Volatility Index®, for example). This leads to the following formula for expected path covariance:

$$Expected path covariance = \frac{2 * {10}^{4} * {e}^{r τ}}{τ} ( {\sum }_{k} \frac{{O}_{K} * Δ K}{{K}^{2}} - {\sum }_{i} {w}_{i}^{2} {\sum }_{j} \frac{{O}_{j}^{i} * Δ {K}_{j}^{i}}{{( {K}_{j}^{i} )}^{2}} ) ,$$

where K is an indicator for index option strikes, i is an indicator for sectors, j is an indicator for strikes of sector options, and the set of strikes is sector-specific. Further, O_{K} is a price of an out-of-the money put or call or an average of an at-the-money put and call. For each sector, the weighted sum of option prices runs over out-of-the-money puts, an average of the at-the-money put and call, then out-of-the-money calls. The constant wᵢ is a cap weight of the i^{tb} sector; r is an annualized money market rate of interest; τ is a time to expiration of the options expressed as a fraction of a year; and the ΔK are determined strike intervals. For the smallest and greatest strike, the strike interval is a difference between the two consecutive strikes. For all other strikes, a strike interval is an average of a difference between the strikes below and above the strike.

Generally, when computing an expected N-day covariance, if there is no index or component options expiring in N days, the N day covariance can be calculated based on expected covariances calculated from options with adjacent expirations. For example in one implementation, when there are no 30-day options listed, a 30-day expected covariance is inter- or extrapolated from expected covariances calculated from options with adjacent expirations, as with CBOE Volatility Index®, for example.

Once the set of underlying assets is chosen at 102 and the formula for generating the value of the statistical property reflecting an implied dispersion between returns associated with the underlying assets of the set of underlying assets is determined at 104, the covariance index may be calculated and a covariance derivative contract based on the covariance index may be created.

At step 105, the covariance index may be calculated and at step 106 the covariance index may be accessed. At step 107, a covariance derivative contract is created based on the accessed covariance index and at step 108 the covariance derivative is assigned a unique symbol. Generally, the covariance derivative contract may be assigned any unique symbol that serves as a standard identifier for the type of standardized covariance derivative contract. At step 109, information associated with the covariance index and/or the covariance derivative contract is transmitted for display, such as transmitting information to list the covariance index and/or the covariance derivative on a trading platform. Examples of the types of information that may be transmitted for display include a settlement price of a covariance derivative, a bid or offer associated with a covariance derivative, a value of a covariance index, and/or a value of one or more underlying assets of the set of underlying assets that a covariance index is associated with.

Generally, a covariance derivative contract may be listed on an electronic platform, an open outcry platform, a hybrid environment that combines the electronic platform and open outcry platform, or any other type of platform known in the art. One example of a hybrid exchange environment is disclosed in U.S. Pat. No. 7,613,650, filed Apr. 24, 2003, the entirety of which is herein incorporated by reference. Additionally, a trading platform such as an exchange may transmit covariance derivative contract quotes of liquidity providers over dissemination networks 110 to other market participants. Liquidity providers may include Designated Primary Market Makers (“DPM”), market makers, locals, specialists, trading privilege holders, registered traders, members, or any other entity that may provide a trading platform with a quote for a variance derivative. Dissemination Networks may include networks such as the Options Price Reporting Authority (“OPRA”), the CBOE Futures Network, an Internet website or email alerts via email communication networks. Market participants may include liquidity providers, brokerage firms, normal investors, or any other entity that subscribes to a dissemination network.

The trading platform executes buy and sell orders for the covariance derivative at step 112. The trading platform may repeat the steps of calculating the covariance index of the underlying asset, accessing the covariance index, transmitting information for the covariance index and/or the covariance derivative for display (list the covariance index and/or covariance derivative on a trading platform), disseminating the covariance index and/or the covariance derivative over a dissemination network, and executing buy and sell orders for the covariance derivative (steps 105, 106, 109, 110, and 112) until the covariance derivative contract is settled at step 114.

In some implementations, covariance derivative contracts may be traded through an exchange-operated parimutuel auction and cash-settled based on the covariance index of log returns of the underlying equity. An electronic parimutuel, or Dutch, auction system conducts periodic auctions, with all contracts that settle in-the-money funded by the premiums collected for those that settle out-of-the-money.

As mentioned, in a parimutuel auction, all the contracts that settle in-the-money are funded by those that settle out-of-the-money. Thus, the net exposure of the system is zero once the auction process is completed, and there is no accumulation of open interest over time. Additionally, the pricing of contracts in a parimutuel auction depends on relative demand; the more popular the strike, the greater its value. In other words, a parimutuel action does not depend on market makers to set a price; instead the price is continuously adjusted to reflect the stream of orders coming into the auction. Typically, as each order enters the system, it affects not only the price of the sought-after strike, but also affects all the other strikes available in that auction. In such a scenario, as the price rises for the more sought-after strikes, the system adjusts the prices downward for the less popular strikes. Further, the process does not require the matching of specific buy orders against specific sell orders, as in many traditional markets. Instead, all buy and sell orders enter a single pool of liquidity, and each order can provide liquidity for other orders at different strike prices and the liquidity is maintained such that system exposure remains zero. This format maximizes liquidity, a key feature when there is no tradable underlying instrument.

While the method described above utilizes an expected covariance index based on defining variances as the quadratic variations of instantaneous rates of return on a path to a final date to calculate a covariance index, it will be appreciated that at step 104, other equations may be used to calculate a covariance index. For example, when the underlying assets are sectors, an expected covariance index may be calculated using an expected covariance based on variances of simple rates of return of the sectors at a final date using the equations:

$$Simple return {R}_{t} = \frac{{F}_{T}}{{F}_{0}} - 1 , and$$

Expected sector point to point covariance=

$$\frac{2 * {10}^{4} * {e}^{r τ}}{τ} ( {\sum }_{k} {O}_{K} * Δ K - {\sum }_{i} {w}_{i}^{2} {\sum }_{j} {O}_{j}^{i} * Δ {K}_{j}^{i} )$$

where F₀ is a forward price of an index or sector at time 0, and F_{T} is a spot value of the index or sector at expiration. Both above and below, variables representing the same values as those previously described have not been described again.

Those of skill in the art will appreciate that the above-recited equation changes a definition of the variance from a sum of variations at every point in time over a calculation period to an expected variance of a final return at an end of the calculation period. This definition of variance may also be replicated by a strip of options that includes a modified weighting scheme.

In yet another implementation, a covariance index may be calculated using an expected sector end-point covariance for log returns using the equations:

$$Log return = ln ( \frac{{F}_{T}}{{F}_{0}} ) , \\ Expected sector point to point covariance of logreturns = \frac{{10}^{14}}{τ} {e}^{r τ} {\sum }_{K} \frac{2 ( 1 - ln ( \frac{K}{{F}_{0}} ) )}{{K}^{2}} {O}_{K} Δ K - {μ}^{2} - {\sum }_{i} {w}_{i}^{2} \frac{{10}^{4}}{τ} {e}^{r τ} ( {\sum }_{j} \frac{2 ( 1 - ln ( \frac{{K}_{j}^{i}}{{F}_{0}^{i}} ) )}{( {K}_{j}^{i} )} {O}_{j}^{i} * Δ {K}_{j}^{i} ) - {μ}_{i}^{2} ) , \\ and$$

$$μ = E [ {R}_{T} ] = \frac{{10}^{4}}{τ} {e}^{r τ} ( - {\sum }_{i} \frac{1}{{K}_{i}^{2}} {O}_{K} {Δ}_{K} ) .$$

Those of skill in the art will appreciate that in the above equations, a return is defined as a log return and variance is defined as variance of a return at an end of a calculation period.

In a further implementation, a covariance index may be calculated using an implied sector at-the-money covariance using the equation:

$$Implied sector at \text{-} the \text{-} money covariance = {σ}^{2} - {\sum }_{i} {w}_{i}^{2} {σ}_{i}^{2}$$

where σ is the at-the-money implied volatility of a strip of options on an index (or portfolio) and on sectors of the index (or portfolio).

In yet another implementation, a covariance index may be calculated using realized covariance based on a simple rate of return and sample variance using the equations:

$${R}_{t} = \frac{{P}_{t}}{{P}_{t - 1}} - 1 , \\ and$$

$$Realized CoVar = α * {10}^{4} ( {\sum }_{t} {( {R}_{t} - \frac{{\sum }_{t} {R}_{t}}{N} )}^{2} - {\sum }_{i} {( {w}_{t - 1}^{i} )}^{2} {( {R}_{t}^{i} - \frac{{\sum }_{t} {R}_{t}^{i}}{N} )}^{2} ) ,$$

where alpha is the annualization factor dependent on a definition of a subperiod. Those of skill in the art will appreciate that the sector weights are cap weights that could be determined every period. Alternatively, the sector weights could be set equal to an initial value, or to an average over the calculation period.

In an additional implementation, a covariance index may be calculated using realized sector covariance based on log return and sample variance using the equation:

$${R}_{t} = ln ( \frac{{P}_{t}}{{P}_{t - 1}} ) , \\ and$$

$$Realized CoVar = α * {10}^{4} ( {\sum }_{t} {( {R}_{t} - \frac{{\sum }_{t} {R}_{t}}{N} )}^{2} - {\sum }_{i} {( {w}_{t - 1}^{i} )}^{2} {( {R}_{t}^{i} - \frac{{\sum }_{t} {R}_{t}^{i}}{N} )}^{2} ) .$$

In a further implementation, a covariance index may be calculated using realized sector covariance based on a sum of squares of simple period rates of returns using the equation:

$$Realized CoVar = α * {10}^{4} ( {\sum }_{t} {R}_{t}^{2} - {\sum }_{i} {( {w}_{t - 1}^{i} )}^{2} {R}_{t}^{{i}^{2}} ) .$$

A covariance index may alternatively be calculated using this same equation where the realized covariance is based on a sum of squared log rates of return.

In yet another implementation, a covariance index may be calculated using realized sector covariance from date 0 to date T using the equation:

$$Realized CoVar = \frac{2}{T} * \{ {\sum }_{i} {w}_{i}^{2} ( ln ( \frac{{F}_{iT}}{{F}_{i 0}} ) - {\sum }_{t} \frac{{Δ}_{t} {F}_{it}}{{F}_{it}} ) - ln ( \frac{{F}_{T}}{{F}_{0}} ) + {\sum }_{t} \frac{{Δ}_{t} {F}_{t}}{{F}_{t}} ) \} ,$$

where Fₜ and Fᵢₜ are forward prices of spot prices at date T as perceived at date t; F_{T} and F_{iT} are the forward prices of the S&P 500 and its sectors at date T, equal to their spot prices at this terminal date T; and wᵢ are sector weights as in the implementations described above. Those of skill in the art will appreciate that forward prices can be estimated from options on the S&P 500 and its sectors that expire at date t.

In the equation above, the term

$$ln ( \frac{{F}_{T}}{{F}_{0}} ) + {\sum }_{t} \frac{{Δ}_{t} {F}_{t}}{{F}_{t}}$$

replicates the continuous realized variance of the index from date 0 to date T, and analogous terms for the sectors replicate the continuously realized variance of the sectors.

In some implementations, any of the covariance index calculations described above may be used to calculate an associated correlation index. The correlation index is determined by dividing a calculated covariance index by a sum of a pairwise cross-product of square roots of sector variances. Continuing with the examples above, a correlation index may be calculated using one of the following equations:

$$Expected Index Path Correlation = ( {\sum }_{k} \frac{{O}_{K} * Δ K}{{K}^{2}} - {\sum }_{i} {w}_{i}^{2} {\sum }_{j} \frac{{O}_{j}^{i} * Δ {K}_{j}^{i}}{{( {K}_{j}^{i} )}^{2}} ) * \frac{1}{{\sum }_{i} {\sum }_{l \neq i} {w}_{i} {{w}_{l} ( {\sum }_{j} \frac{{O}_{j}^{i} * Δ {K}_{j}^{i}}{{( {K}_{j}^{i} )}^{2}} )}^{1 / 2} * {( {\sum }_{j} \frac{{O}_{j}^{l} * Δ {K}_{j}^{l}}{{( {K}_{j}^{l} )}^{2}} )}^{1 / 2}} \\ Correlation based on expected point to point covariance = ( {\sum }_{K} \frac{2 ( 1 - ln ( \frac{K}{{F}_{0}} ) )}{{K}^{2}} {O}_{K} Δ K - {μ}^{2} - {\sum }_{i} {w}_{i}^{2} {\sum }_{j} \frac{2 ( 1 - ln ( \frac{{K}_{j}^{i}}{{F}_{0}^{i}} ) )}{{( {K}_{j}^{i} )}^{2}} {O}_{j}^{i} * Δ {K}_{j}^{i} ) - {μ}_{i}^{2} ) * \frac{1}{\begin{matrix}{( {\sum }_{i} {\sum }_{l \neq i} {w}_{i} {w}_{l} ( {\sum }_{j} \frac{2 ( 1 - ln ( \frac{{K}_{j}^{i}}{{F}_{0}^{i}} ) )}{{( {K}_{j}^{i} )}^{2}} {O}_{j}^{i} * Δ {K}_{j}^{i} ) - {μ}_{i}^{2} )}^{1 / 2} * \\ {( {\sum }_{j} \frac{2 ( 1 - ln ( \frac{{K}_{j}^{l}}{{F}_{0}^{i}} ) )}{{( {K}_{j}^{l} )}^{2}} {O}_{j}^{i} * Δ {K}_{j}^{l} ) - {μ}_{l}^{2} )}^{1 / 2}\end{matrix}}$$

Realized Correlation from realized sector covariance based on sum of squared standard period rates of return:

$$ρ = \frac{1}{N} {\sum }_{t} \frac{{R}_{t}^{2} - {\sum }_{i} {w}_{{i}_{t - 1}}^{2} {R}_{i , t}^{2}}{{\sum }_{i} {\sum }_{l \neq i} {w}_{i , t - 1} {w}_{l , t - 1} \vert {R}_{i , t} \vert \vert {R}_{l , t} \vert}$$

It will be appreciated that a correlation index may be used in ways similar to those described with respect to the covariance index described above in conjunction with FIG. 1. For example, the derivative, such as a correlation option or a correlation future may trade on an exchange based on a calculated correlation index.

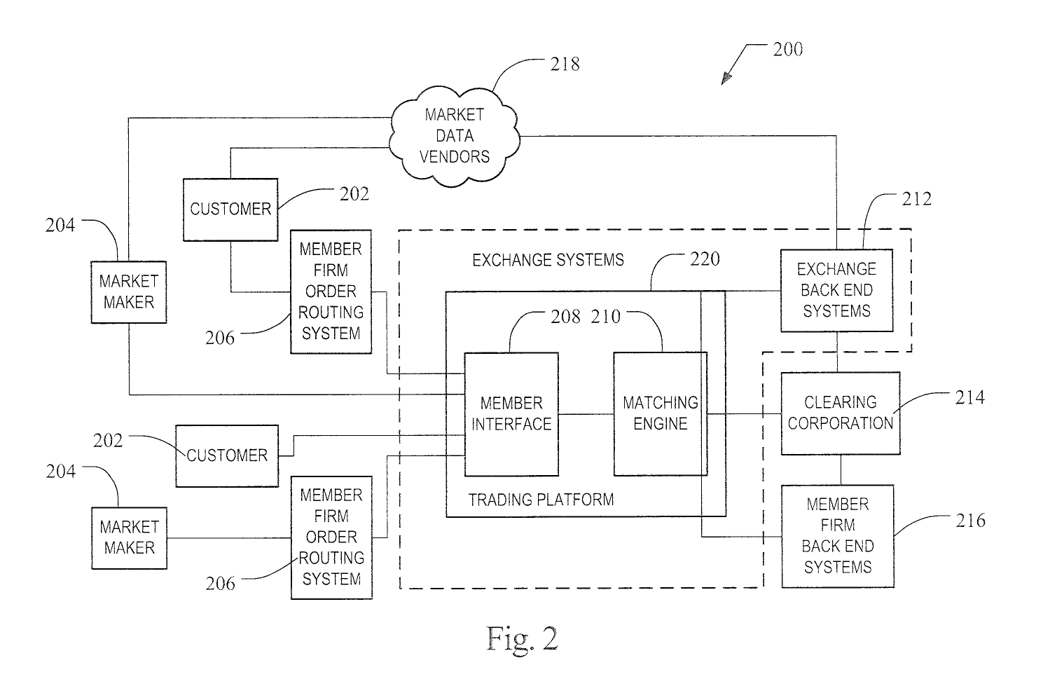

FIG. 2 illustrates an electronic trading system 200 which may be used for creating and disseminating a covariance index and/or creating, listing and trading covariance derivative contracts that are based on a covariance index. It will be appreciated that the described systems may implement the methods described above with respect to FIG. 1, and that a similar system may be utilized with respect to a correlation index used in conjunction with creating, listing, and trading correlation derivative contracts that are based on a correlation index.

The system 200 includes components operated by an exchange, as well as components operated by others who access the exchange to execute trades. The components shown within the dashed lines are those operated by the exchange. Components outside the dashed lines are operated by others, but nonetheless are necessary for the operation of a functioning exchange. The exchange components of the trading system 200 include an electronic trading platform 220, a member interface 208, a matching engine 210, and backend systems 212. Backend systems not operated by the exchange but which are integral to processing trades and settling contracts are the Clearing Corporation's systems 214, and Member Firms' backend systems 216.

Market Makers may access the trading platform 220 directly through personal input devices 204 which communicate with the member interface 208. Market makers may quote prices for covariance derivative contracts. Non-member Customers 202, however, must access the exchange through a Member Firm. Customer orders are routed through Member Firm routing systems 206. The Member Firms' routing systems 206 forward the orders to the exchange via the member interface 208. The member interface 208 manages all communications between the Member Firm routing systems 206 and Market Makers' personal input devices 204; determines whether orders may be processed by the trading platform; and determines the appropriate matching engine for processing the orders. Although only a single matching engine 210 is shown in FIG. 2, the trading platform 220 may include multiple matching engines. Different exchange traded products may be allocated to different matching engines for efficient execution of trades. When the member interface 202 receives an order from a Member Firm routing system 206, the member interface 208 determines the proper matching engine 210 for processing the order and forwards the order to the appropriate matching engine. The matching engine 210 executes trades by pairing corresponding marketable buy/sell orders. Non-marketable orders are placed in an electronic order book.

Once orders are executed, the matching engine 210 sends details of the executed transactions to the exchange backend systems 212, to the Clearing Corporation systems 214, and to the Member Firms' backend systems 216. The matching engine also updates the order book to reflect changes in the market based on the executed transactions. Orders that previously were not marketable may become marketable due to changes in the market. If so, the matching engine 210 executes these orders as well.

The exchange backend systems 212 perform a number of different functions. For example, contract definition and listing data originate with the Exchange backend systems 212. The covariance index and pricing information for covariance derivative contracts associated with the covariance index are disseminated from the exchange backend systems to market data vendors 218. Customers 202, market makers 204, and others may access the market data regarding the covariance index and covariance derivative contracts based on the covariance index via, for example, proprietary networks, on-line services, and the like. The exchange backend systems also evaluate the underlying asset or assets on which the covariance derivative contracts are based. At expiration, the backend systems 212 determine the appropriate settlement amounts and supply final settlement data to the Clearing Corporation. The Clearing Corporation acts as the exchange's bank and performs a final mark-to-market on Member Firm margin accounts based on the positions taken by the Member Firms' customers. The final mark-to-market reflects the final settlement amounts for the covariance derivative contracts, and the Clearing Corporation debits/credits Member Firms' accounts accordingly. These data are also forwarded to the Member Firms' systems 216 so that they may update their customer accounts as well.

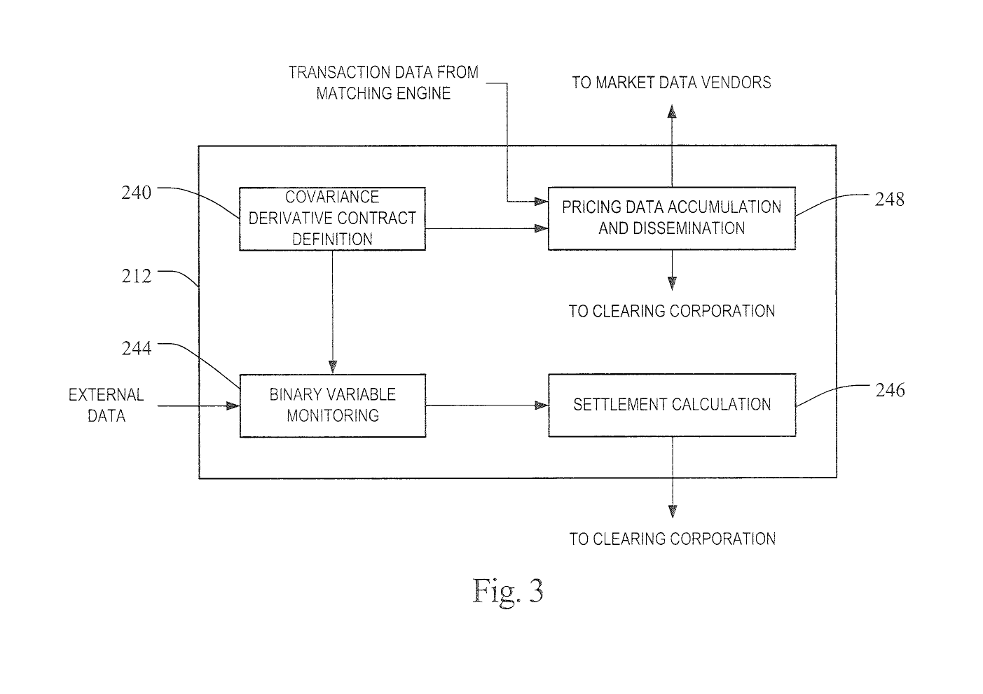

FIG. 3 shows the exchange backend systems 212 used for creating and disseminating a covariance index and/or creating, listing and trading covariance derivative contracts that are based on a covariance index in more detail. A covariance derivative contract definition module 240 stores all relevant data concerning the covariance derivative contract to be traded on the trading platform 220, including, for example, the contract symbol, a definition of the underlying asset or assets associated with the covariance derivative, or a term of a calculation period associated with the covariance derivative. A pricing data accumulation and dissemination module 248 receives contract information from the covariance derivative contract definition module 240 and transaction data from the matching engine 210. The pricing data accumulation and dissemination module 248 provides the market data regarding open bids and offers and recent transactions to the market data vendors 218. The pricing data accumulation and dissemination module 248 also forwards transaction data to the Clearing Corporation so that the Clearing Corporation may mark-to-market the accounts of Member Firms at the close of each trading day, taking into account current market prices for the covariance derivative contracts. Finally, a settlement calculation module 246 receives input from the covariance derivative monitoring module 244. On the settlement date the settlement calculation module 246 calculates the settlement amount based on the covariance index value associated with the set of underlying assets. The settlement calculation module 246 forwards the settlement amount to the Clearing Corporation, which performs a final mark-to-market on the Member Firms' accounts to settle the covariance derivative contract.

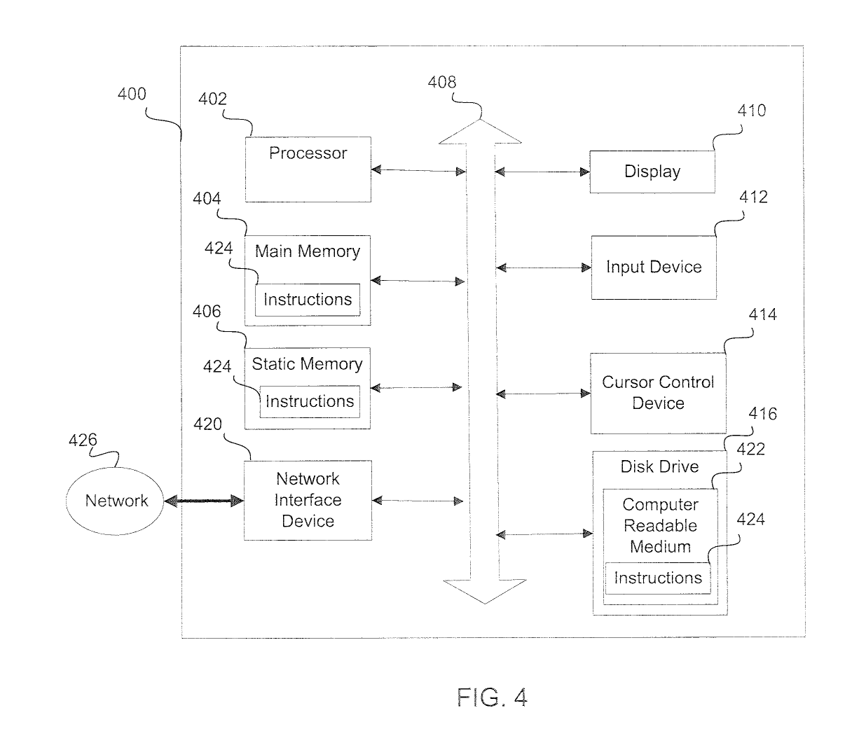

Referring to FIG. 4, an illustrative embodiment of a general computer system that may be used for one or more of the components shown in FIG. 3, or in any other trading system configured to carry out the methods discussed above, is shown and is designated 400. The computer system 400 can include a set of instructions that can be executed to cause the computer system 400 to perform any one or more of the methods or computer based functions disclosed herein. The computer system 400 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 400 can also be implemented as or incorporated into various devices, such as a personal computer (PC), a tablet PC, a set-top box (STB), a personal digital assistant (PDA), a mobile device, a palmtop computer, a laptop computer, a desktop computer, a network router, switch or bridge, or any other machine capable of executing a set of instructions (sequential or otherwise) that specify actions to be taken by that machine. In a particular embodiment, the computer system 400 can be implemented using electronic devices that provide voice, video or data communication. Further, while a single computer system 400 is illustrated, the term “system” shall also be taken to include any collection of systems or sub-systems that individually or jointly execute a set, or multiple sets, of instructions to perform one or more computer functions.

As illustrated in FIG. 4, the computer system 400 may include a processor 402, e.g., a central processing unit (CPU), a graphics processing unit (GPU), or both. Moreover, the computer system 400 can include a main memory 404 and a static memory 406 that can communicate with each other via a bus 408. As shown, the computer system 400 may further include a video display unit 410, such as a liquid crystal display (LCD), an organic light emitting diode (OLED), a flat panel display, a solid state display, or a cathode ray tube (CRT). Additionally, the computer system 400 may include an input device 412, such as a keyboard, and a cursor control device 414, such as a mouse. The computer system 400 can also include a disk drive unit 416, a signal generation device 418, such as a speaker or remote control, and a network interface device 420.

In a particular embodiment, as depicted in FIG. 4, the disk drive unit 416 may include a computer-readable medium 422 in which one or more sets of instructions 424, e.g. software, can be embedded. Further, the instructions 424 may embody one or more of the methods or logic as described herein. In a particular embodiment, the instructions 424 may reside completely, or at least partially, within the main memory 404, the static memory 406, and/or within the processor 402 during execution by the computer system 400. The main memory 404 and the processor 402 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 424 or receives and executes instructions 424 responsive to a propagated signal, so that a device connected to a network 426 can communicate voice, video or data over the network 426. Further, the instructions 424 may be transmitted or received over the network 426 via the network interface device 420.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols commonly used by investment management companies, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

### Illustrative Example

As discussed above, a covariance index may be calculated based on an implied sector at-the-money covariance using the equation:

Implied sector at-the-money covariance=σ²−Σᵢωᵢ²σᵢ²

Table 1 below illustrates sample components that may be used to calculate a covariance index.

TABLE 1

| | | | | | | Staple | Cautionary | | | S&P |
|---|---|---|---|---|---|---|---|---|---|---|
| | Health | Utilities | Industrial | Materials | Financials | Consumer | Consumer | Tech | Energy | 500 |
| 30 day | 16.09 | 13.08 | 22.57 | 25.71 | 28.50 | 13.28 | 20.20 | 19.68 | 25.24 | 18.98 |
| implied | | | | | | | | | | |
| volatilities | | | | | | | | | | |
| Sector | 12% | 4% | 10% | 3% | 13% | 12% | 11% | 22% | 12% | |
| Weights | | | | | | | | | | |
| Squared | 0.01 | 0.00 | 0.01 | 0.00 | 0.02 | 0.02 | 0.02 | 0.05 | 0.01 | |
| Sector | | | | | | | | | | |
| Weights | | | | | | | | | | |
| Variances | 259.02 | 171.18 | 509.18 | 660.85 | 812.20 | 176.45 | 407.93 | 387.20 | 637.16 | 360.17 |
| Squared | 3.54 | 0.25 | 5.52 | 0.79 | 14.28 | 2.67 | 4.62 | 19.32 | 9.27 | |
| Weights * | | | | | | | | | | |
| vars | | | | | | | | | | |
| Index var | | | | | | | | | | 299.81 |
| minus | | | | | | | | | | |
| weighted | | | | | | | | | | |
| vars | | | | | | | | | | |
| Expected | | | | | | | | | | 17.32 |
| CoVal | | | | | | | | | | |

In Table 1, the first row of the table includes values for implied volatilities for S&P 500 sectors and the S&P 500, σᵢ and σ in the equation above. These implied volatilities are calculated from option prices using the Black option pricing model, known to those of skill in the art. The second row of the table illustrates values for the weights wᵢ and the third row illustrates values for the squared weights. The weight of the i^{tb} sector is the total market capitalization of stocks in that sector divided by the total market capitalization of stocks in all sectors.

The fourth row of the table illustrates the implied variances, the squares of the implied volatilities. The fifth row of the table illustrates the products of squared weights and squared variances, wᵢ² σᵢ² in the equation above.

The sixth row of the table illustrates expected covariance, which is the difference between the index and the sum of sector variances multiplied by the squared weights, the value 299.81 in Table 1. Finally, the seventh row of the table illustrates the expected covolatility, which is equal to 17.32, the square root of 299.81.

It will be appreciated that other covariance index values may be calculated using the various implementations described above and similar values from Table 1. For example, a covariance index may be calculated using expected path covariance as described above, where after calculating expected variances for the S&P 500 and its sections, these values are inserted into Table 1 at the fourth row. The above-described process is then repeated to calculate expected covariance and expected covolatility.

Similarly, covariance indexes based on realized covariance may be based on the values of Table 1 and realized returns from daily market capitalizations. For example, as described above, a covariance index may be calculated using realized covariance based on a simply rate of return and simple variance using the equations:

$${R}_{t} = ln ( \frac{{P}_{t}}{{P}_{t - 1}} ) , \\ and$$

$$Realized CoVar = α * {10}^{4} ( {\sum }_{t} {( {R}_{t} - \frac{{\sum }_{t} {R}_{t}}{N} )}^{2} - {\sum }_{i} {( {w}_{t - 1}^{i} )}^{2} {( {R}_{t}^{i} - \frac{{\sum }_{t} {R}_{t}^{i}}{N} )}^{2} ) .$$

It will be appreciated that in this equation, the first term of the realized covariance expression may be the realized variance of the S&P 500, and its value may be included in the fourth row under S&P 500 variance. Additionally, the i^{tb} term of the second term is the realized variance of the i^{tb} sector, and its value may be included in the fourth row under i^{tb} sector variance. The calculation of the covariance index would then proceed as described above with the determination of the sector weights

The realized returns may be calculated from daily market capitalizations. For example, to calculate realized return Rⁱₜ of the i^{th} sector on date t, the market caps Pₜ of the sector at close of both dates is determined and substituted into the equation for the return above. The same process is repeated for the S&P 500 (sum the market caps for all sectors on dates t−1 and date t at the close) and then substituted into the equation for Rₜ. One example of sector market caps on two successive days is shown below in Table 2.

TABLE 2

| | | | | | | Staple | Cautionary | | |
|---|---|---|---|---|---|---|---|---|---|
| | Health | Utilities | Industrial | Materials | Financials | Consumer | Consumers | Tech | Energy |
| Date t-1 | 1294702.88 | 421283.6 | 1161098 | 386378.7 | 1491467 | 1384413.6 | 1187831.1 | 2567041.6 | 1331501 |
| Date t | 1309368.63 | 426941 | 1169050 | 388840.6 | 1492048 | 1397595.8 | 1189960.1 | 2554704 | 1328318 |

After the sequence of daily returns (e.g., 30 days for a monthly covariance) is calculated for the S&P 500 and all its sectors, the realized variances of the S&P 500 and its sectors may be calculated. For variations such as squared log returns, the daily returns are calculated as described above, and the logarithms and squares of the resulting values are calculated as appropriate. The above-described process is then repeated to calculate the realized covariance.

It is intended that the foregoing detailed description be regarded as illustrative rather than limiting, and that it be understood that it is the following claims, including all equivalents, that are intended to define the spirit and scope of this invention.

1. A computer-implemented method of determining an index based on a covariance between two underlying assets, the method comprising:
with a processor in a trading platform:
calculating a covariance index associated with two underlying assets;
creating a covariance derivative associated with the two underlying assets based on the covariance index associated with the two underlying asset; and
displaying the covariance index associated with the two underlying assets and the covariance derivative associated with the two underlying assets on a trading platform display device coupled with the trading platform;
wherein the covariance index is calculated based on the equation:
cov(R₁,R₂)=E[(R₁−E[R₁])(R₂−E[R₂])]=ρ_{1,2}σ₁σ₂
where R₁ is a return of a first underlying asset of the two underlying assets, R₂ is a return of the second underlying asset of the two underlying assets, E[x] is an expected value of x, σ₁ is a standard deviation of a return of the first underlying asset, σ₂ is a standard deviation of a return of the second underlying asset, and ρ_{1,2} is a correlation between the rate of return of the first underlying asset and the rate of return of the second underlying asset.

2. The computer-implemented method of claim 1, wherein the first underlying asset represents a first sector of the S&P 500® and the second underlying asset represents a second sector of the S&P 500®.

3. The computer-implemented method of claim 1, wherein the first underlying asset represents a first sector of a portfolio and the second underlying asset represents a second sector of the portfolio.

4. The computer-implemented method of claim 3, wherein the covariance index is calculated based on the equation:
$$Expected path covariance = \frac{2 * {10}^{4} * {e}^{r τ}}{τ} ( {\sum }_{k} \frac{{O}_{K} * Δ K}{{K}^{2}} - {\sum }_{i} {w}_{i}^{2} {\sum }_{j} \frac{{O}_{j}^{i} * Δ {K}_{j}^{i}}{{( {K}_{j}^{i} )}^{2}} ) ,$$
where K is an indicator for index option strikes; i is an indicator for sectors; j is an indicator for strikes of sector options; O_{K} is a price of an out-of-the money put or call or an average of an at-the-money put and call; wᵢ is a cap weight of the i^{tb} sector; r is an annualized money market rate of interest; τ is a time to expiration of the options expressed as a fraction of a year; and the ΔK are determined strike intervals.

5. The computer-implemented method of claim 3, wherein the first sector and the second sector each comprise one or more of commodity or structured products traded on a trading platform or over-the-counter market; equity indexes or securities; fixed income indexes or securities; foreign currency exchange rates; interest rates; and commodity indexes.

6. The computer-implemented method of claim 1, further comprising:
transmitting the covariance index associated with the two underlying assets over at least one electronic dissemination network.

7. The computer-implemented method of claim 1, wherein the trading platform is an exchange.

8. The computer-implemented method of claim 1, wherein the covariance derivative is a covariance option.

9. The computer-implemented method of claim 1, wherein the covariance derivative is a covariance future.

10. The computer-implemented method of claim 1, further comprising:
calculating a correlation index based on the covariance index;
creating a correlation derivative associated with the two underlying assets based on the correlation index; and
displaying the correlation index associated with the two underlying assets and the correlation derivative associated with the two underlying assets on the trading platform display device coupled with the trading platform.

11. A trading system comprising:
a display device;
a memory storing a set of instructions for calculating a covariance index associated with two underlying assets and creating a covariance derivative associated with the two underlying assets based on the covariance index; and
a processor in communication with the display device and the memory, the processor configured to execute the set of instructions stored in the memory and to:
calculate a covariance index associated with two underlying assets;
create a covariance derivative associated with the two underlying assets based on the covariance index; and
display the covariance index associated with the two underlying assets and the covariance derivative associated with the covariance index on the display device;
wherein the covariance index is calculated based on the equation:
cov(R₁,R₂)=E[(R₁−E[R₁])(R₂−E[R₂])]=ρ_{1,2}σ₁σ₂
where R₁ is a return of a first underlying asset of the two underlying assets, R₂ is a return of the second underlying asset of the two underlying assets, E[x] is an expected value of x, σ₁ is a standard deviation of a return of the first underlying asset, σ₂ is a standard deviation of a return of the second underlying asset, and ρ_{1,2} is a correlation between the rate of return of the first underlying asset and the rate of return of the second underlying asset.

12. The trading system of claim 11, wherein the first underlying asset represents a first sector of a portfolio and the second underlying asset represents a second sector of the portfolio; and
wherein the processor is further configured calculate the covariance index based on the equation:
$$Expected path covariance = \frac{2 * {10}^{4} * {e}^{r τ}}{τ} ( {\sum }_{k} \frac{{O}_{K} * Δ K}{{K}^{2}} - {\sum }_{i} {w}_{i}^{2} {\sum }_{j} \frac{{O}_{j}^{i} * Δ {K}_{j}^{i}}{{( {K}_{j}^{i} )}^{2}} ) ,$$
where K is an indicator for index option strikes; i is an indicator for sectors; j is an indicator for strikes of sector options; O_{K} is a price of an out-of-the money put or call or an average of an at-the-money put and call; wᵢ is a cap weight of the i^{tb} sector; r is an annualized money market rate of interest; τ is a time to expiration of the options expressed as a fraction of a year; and the ΔK are determined strike intervals

13. The trading system of claim 12, wherein the first sector and the second sector each comprise one or more of commodity or structured products traded on a trading platform or over-the-counter market; equity indexes or securities; fixed income indexes or securities; foreign currency exchange rates; interest rates; and commodity indexes.

14. A computer-implemented method of creating a covariance derivative, the method comprising:
accessing a covariance index associated with two underlying assets;
creating, with a processor, a covariance derivative based on the covariance index; and
transmitting, with the processor, information associated with the covariance derivative for display;
wherein the covariance index is calculated based on the equation:
cov(R₁,R₂)=E[(R₁−E[R₁])(R₂−E[R₂])]=ρ_{1,2}σ₁σ₂
where R₁ is a return of a first underlying asset of the two underlying assets, R₂ is a return of the second underlying asset of the two underlying assets, E[x] is an expected value of x, σ₁ is a standard deviation of a return of the first underlying asset, σ₂ is a standard deviation of a return of the second underlying asset, and ρ_{1,2} is a correlation between the rate of return of the first underlying asset and the rate of return of the second underlying asset.

15. The computer-implemented method of claim 14, wherein the first underlying asset represents a first sector of the S&P 500® and the second underlying asset represents a second sector of the S&P 500®.

16. The computer-implemented method of claim 14, wherein the first underlying asset represents a first sector of a portfolio and the second underlying asset represents a second sector of the portfolio; and
wherein the covariance index is calculated based on the equation:
$$Expected path covariance = \frac{2 * {10}^{4} * {e}^{r τ}}{τ} ( {\sum }_{k} \frac{{O}_{K} * Δ K}{{K}^{2}} - {\sum }_{i} {w}_{i}^{2} {\sum }_{j} \frac{{O}_{j}^{i} * Δ {K}_{j}^{i}}{{( {K}_{j}^{i} )}^{2}} ) ,$$
where K is an indicator for index option strikes; i is an indicator for sectors; j is an indicator for strikes of sector options; O_{K} is a price of an out-of-the money put or call or an average of an at-the-money put and call; wᵢ is a cap weight of the i^{tb} sector; r is an annualized money market rate of interest; τ is a time to expiration of the options expressed as a fraction of a year; and the ΔK are determined strike intervals.

17. The computer-implemented method of claim 16, wherein the first sector and the second sector each comprise one or more of commodity or structured products traded on a trading platform or over-the-counter market; equity indexes or securities; fixed income indexes or securities; foreign currency exchange rates; interest rates; and commodity indexes.

18. The computer-implemented method of claim 14, wherein the covariance derivative is a covariance option.

19. The computer-implemented method of claim 14, wherein the covariance derivative is a covariance future.

20. A system comprising:
a memory storing a set of instructions for creating a covariance derivative; and
a processor in communication with the memory, the processor configured to execute the set of instructions stored in the memory and to:
access a covariance index associated with two underlying assets;
create the covariance derivative based on the covariance index; and
transmit information associated with the covariance derivative for display;
wherein the covariance index is calculated based on the equation:
cov(R₁,R₂)=E[(R₁−E[R₁])(R₂−E[R₂])]=ρ_{1,2}σ₁σ₂
where R₁ is a return of a first underlying asset of the two underlying assets, R₂ is a return of the second underlying asset of the two underlying assets, E[x] is an expected value of x, σ₁ is a standard deviation of a return of the first underlying asset, σ₂ is a standard deviation of a return of the second underlying asset, and ρ_{1,2} is a correlation between the rate of return of the first underlying asset and the rate of return of the second underlying asset.
